(19) United States
(12) Patent Application Publication
(10) Pub. No.: US 2014/0156323 A1
(43) Pub. Date: Jun. 5, 2014

(54) RESILIENCY ASSESSMENT AND MANAGEMENT SYSTEM

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 14/086,690

(22) Filed: Nov. 21, 2013

Related U.S. Application Data
(60) Provisional application No. 61/732,193, filed on Nov. 30, 2012.

(51) Int. Cl. G06Q 50/08; G06Q 10/06

(52) U.S. Cl. CPC G06Q 50/08; G06Q 10/0631
USPC 705/7.12

(57) ABSTRACT

A program resiliency management system having a resilience management engine that can generate a resiliency metric representative of how resilient a program is with respect to a particular event. The resiliency metric can be based on the characteristics of a program represented by program features and features related to the impact a particular event has on a program. The resilience of a program represented by the resiliency metric can be with respect to a program's capacity to resist an event, respond to the event, and recover from the event.

This application claims benefit of priority to U.S. provisional application 61/732,193, filed Nov. 30, 2012. U.S. provisional application 61/732,193 is incorporated herein by reference in its entirety.

### FIELD OF THE INVENTION

The field of the invention is engineering and construction program management technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Private and public entities increasingly are undertaking large scale capital construction programs utilizing a program management approach. The growing scale, complexity and durations of these programs require the use of a comprehensive and integrated management system incorporating features, techniques, work processes and tools not found in current project management tools. These entities typically engage external entities to provide various elements of these program management services but no comprehensive integrated management system exists today.

Key features required in the management of the delivery of these large programs include identifying, assessing, modeling, analyzing, forecasting, tracking, managing and reporting on a wide range of outcomes, outputs, processes, constraints and drivers. Currently, strategic business objective tracking, governance assessment, strategy phase activities and resiliency assessment are not addressed in existing management systems. Additionally these efforts have been confined to the capital project delivery phase and not extended into initial operations and long term operations and maintenance.

Features of existing project management systems which are often employed in a program management context currently lack an ability to provide insight into a program's resilience to internal or external forces or event even if they are a priori known or unknown.

Thus, there is still a need for resiliency assessment and management systems.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a program resiliency management system can identify how resilient a program is with respect to resisting, responding, or recovering from one or more events. Contemplated management systems include a program interface through which program managers supply the system with program information, including program features, associated with their program. The system can also include one or more event databases storing events having attributes that describe the nature of the event as well as having attributes that indicate how the event can impact programs.

A resilience management engine can be configured to obtain program features from the program interface. Based on the program features, the engine can generate event selection criteria that outline attributes of events that could be considered relevant to the program. The engine uses the selection criteria to search the event database for events having attributes that satisfy the criteria, thus indicating, at least to some level, their relevance to the program. The engine can then select one or more events from the returned set of events as possible targets for further analysis. The engine derives a resiliency metric of the program based on the program features supplied via the program interface and based on the program impact attributes of the selected events. The resiliency metric can then be sent to an output device for presentation to an end user.

The resiliency metric can be used to generate a recommendation that can be presented to the user via the output device. Additionally, the system can generate notifications based on meeting triggering conditions. The notifications can be presented to the user via the output device.

In embodiments, one or more processing subassemblies can be employed to generate program measures or output program features based on “raw” input program features. The resilience management engine can then use the output of the subassemblies, along with program impact attributes of an identified or selected event to generate the resiliency metric.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an overview of a program resiliency management system.

FIG. 2 provides an illustrative example of program information and an event.

FIG. 3 is an overview of a sample generation of a resiliency metric based a resistance measure, a response measure, and a recovery measure.

FIG. 4 is an overview of a first portion of a subassembly structured approach that can be used to generate a resiliency metric.

FIG. 5 is an overview of a second portion of the subassembly structured approach that can be used to generate a resiliency metric.

FIG. 6 is an overview of a third portion of the subassembly structured approach that can be used to generate a resiliency metric.

FIG. 7 provides a detailed overview of the generation a resistance measure according to a resistance subassembly.

FIG. 8 provides a detailed overview of the generation a response measure according to a response subassembly.

FIG. 9 provides a detailed overview of the generation a recovery measure according to a recovery subassembly.

### DETAILED DESCRIPTION

It should be noted that while the following description is drawn to a computer/server based program management systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques include generating one or more electronic signals representative of resilience of a program (e.g., engineering, construction, collections of projects, etc.). The electronic signals configure output devices to present or render information related to the program resilience.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

One should appreciate that the term “program” as used herein is considered to mean a collection of one or more projects, construction projects for example, rather than a software application. A program can include multiple projects underway in parallel, projects operating serially, multiple project phases, or other collection of activities. Although the following discussion main relates to large scale engineering or construction programs, it is noted that the disclosed techniques can also be applied to other types of programs. Other types of programs can include software development programs or implementation of human resource programs, just to name a few.

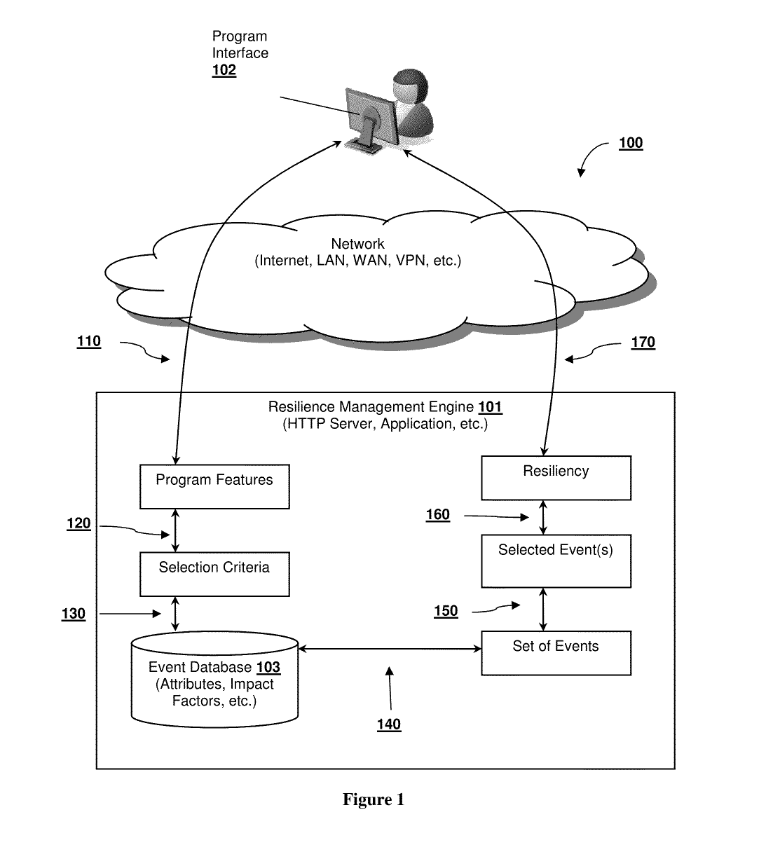

FIG. 1 illustrates a program management ecosystem 100 that includes a resilience management engine 101, a program interface 102, and an event database 103. FIG. 1 also illustrates an exemplary execution of functions and methods according to an embodiment of the inventive subject matter.

In embodiments, the resilience management engine 101 can comprise computer-executable instructions stored on one or more non-transitory computer-readable media (e.g., hard drives, solid state drives, RAM, optical media, server storage media, etc.) that, when executed by one or more processors, cause the processor to carry out the functions and processes of the inventive subject matter corresponding to the engine 101.

In embodiments, the resilience management engine 101 can comprise one or more specially programmed computing processors, specifically programmed to carry out the functions and processes of the inventive subject matter corresponding to the engine 101. In further embodiments, the resilience management engine 101 can be a dedicated computing device including these specially programmed processors. In these embodiments, the resilience management engine 101 can also include memory, network interfaces (e.g., Ethernet, cable, USB, WiFi, cellular, HDMI, etc.) capable of exchanging data with other computing devices, input user interfaces (e.g., mouse, keyboard, microphone, etc.), output user interfaces (e.g., displays, audio output devices, sensory feedback devices, etc.), or other computing device hardware components.

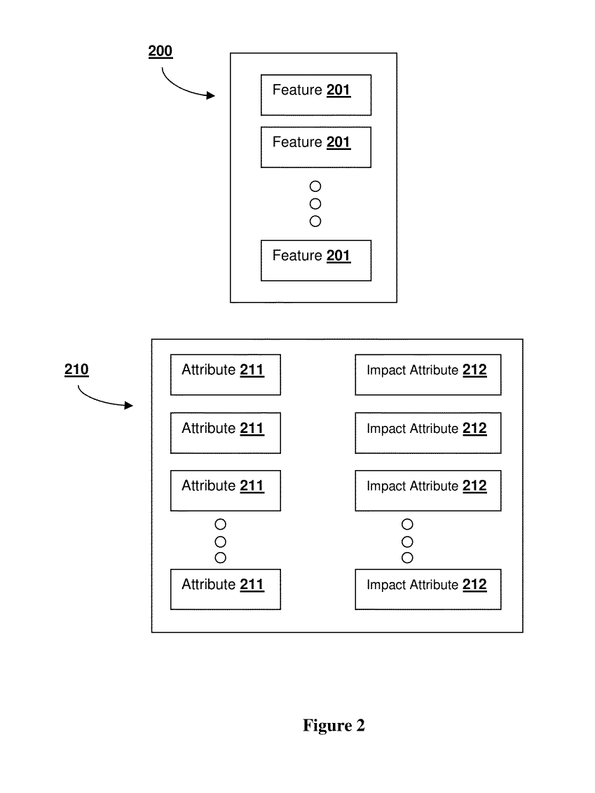

In order to conduct an analysis regarding a program according to the inventive subject matter, the resiliency management engine 101 can first gather digital program information about the program targeted in the analysis at step 110. Program features can be provided to the resiliency management engine 101 via the program interface 102, which can be communicatively connected with the engine 101 and other components of the system over a network (e.g., the Internet). FIG. 2 provides an illustrative example of program information 200, including a plurality of program features 201.

The program features 201 can be obtained by the program interface 102 from one or more sources. For example, program features 201 can be obtained from databases associated with the program (e.g., program reports), administrative databases (e.g., containing program proposals, authorizations, contracts, details, operational data, etc.), sensors, program equipment reports (e.g., generated by equipment or machinery used in a program, such as regarding equipment operating status, diagnostics, periodic reporting, etc.). Program features can also be supplied by a user such as a program manager or other authorized person, whereby the program interface 102 can be a data input application on a computing device accessed by the user to provide the program features.

Program features can be provided via modeling assemblies or as a result of program modeling processes that can used to model various aspects of a program and/or the entire program over a particular period of time, or over the course of the projected lifetime of a program. One example of a suitable modeling assembly is a 7D modeling assembly, such as the one described in co-owned Applicant's U.S. application Ser. No. 13/797,564, to Prieto titled “Multi-Dimensional Life Cycle Project Execution System”, filed Mar. 12, 2013, published as U.S. patent application publication 2013/0238379. U.S. application Ser. No. 13/797,564 is incorporated by reference in its entirety.

Program features related to particular programs can be gathered and stored in a program database for future use by the resilience management engine 101. For example, program features can be automatically gathered by the program interface 102 upon the creation of a program, and over time as a program is implemented and executed. The program features can be updated over time, and as such the program database can store program features reflecting the state of a program at various points in time. When an analysis is requested by a user, or as a periodic analysis performed by the engine 101, the program interface 102 can provide the program features stored in the program database to the engine 101.

Program features 201 can comprise quantified aspects or characteristics of a target program. Example program features 201 can include a repair status, a training status, one or more logistic features, personnel data, business objectives, plan status, subject matter expert review, stakeholder alignment data, cultural factors, supply chain data, regulations, program history, or other characteristics of the program of interest. The program features 201 can comprise data objects having feature fields and feature field values. The feature fields can correspond to particular characteristics of a feature, and the feature field values corresponding to the quantified aspect of the particular characteristic. The feature field values can include numerical and/or non-numerical values stored according to one or more corresponding data structures.

Based on the program features 201, the engine 101 can generate event selection criteria at step 120, that serve to outline how to determine which events can be related to the program, or can be considered to be most relevant to the program. The selection criteria can be defined based on the same namespace or ontology on which the event attributes are defined, thus easing the search for events.

The event selection criteria can comprise a collection of one or more individual criterion, and can include a rule set that govern how the collective criteria influence the selection of events by the resilience management engine 101. It should be appreciated that the event selection criteria takes the form of computer instructions or conditions.

In embodiments, event selection criteria can be generated by the resilience management engine 101 based on one or more of the received program features 201, such as an individual feature, a subset of the received program features, or all of the features.

Program features used as the basis for the event selection criteria can be features grouped according to a categorization of features, statistical analysis, or other criteria. Thus, the event selection criteria can be based on one or more features deemed to be those that most influence a particular program's resilience (e.g., those most susceptible to an event, those most resistant to an event, those deemed to be most at risk to an event, etc.). Additionally, the event selection criteria can be generated based on a statistical analysis (e.g., clustering analysis, means-squared, etc.) of program features, and the relationships between the features shown by the statistical analysis. The event selection criteria can then be generated based on a cluster of features having certain cluster characteristics. The event selection criteria can be also generated based on a pre-categorized set of features, such as “administrative features”, “infrastructural features”, “long-term features”, “cost-impact features”, “information security features” etc. In embodiments, one or more of the features used to generate event selection criteria can be user-selected.

In embodiment, one or more of the criterion can be user-defined. For example, a user can designate a particular event type to include in the event selection criteria, so that the selected event(s) are those of the desired type. In another example, the user can designate one or more features as event selection criteria, such that the event selected is at least in part selected based on a relevance to the user-designated feature(s).

In embodiments, the event selection criteria can include general criteria. Examples of criterion that can be considered general criterion include program type, program category, program location, program duration, program timeframe, event type, event category, event size, event magnitude, etc.

At step 130, the engine 101 is configured to use the selection criteria to search the event database 103 for events having event attributes that satisfy the selection criteria. FIG. 2 provides an illustrative example of an event 210, having event attributes 211.

Events can be stored in an event database 103. The events database can comprise one or more non-transitory computer-readable storage mediums (e.g., one or more server computers, hard drives, solid state drives, flash memory, optical media, etc.) configured to store the events. Stored events can be in the form of event objects, representing particular events. The events can include historical events that have occurred, as well as hypothetical events (e.g., predicted events, modeled events, etc.) that can impact a program. Example events can include a supply chain event, a disaster event, a natural event, a technology change, a personnel event, an internal project event, an internal program, an environmental event, a legislative event, a regulatory event, a conflict event, black swan events, or other type of events. Thus, each type of event can be stored within event database 103 as a corresponding event object. For example, each type of event could be represented as a blank event template, say a regulatory event template, which can then have its blank fields populated with specific event information (e.g., jurisdiction, scope, cost impact, etc.). Event objects could be stored as packed binary data, or in a more human readable format possibly based on XML.

Event attributes 211 can be considered characteristics of an event or that otherwise describe the nature of the events. In some embodiments, the attributes can comprise values that adhere to a common namespace or ontology. For example, event attributes can include an event type attribute, an event time attribute (e.g., when the event happens, or when it begins, etc.), an event duration attribute (e.g., how long the event lasts once it has started), an event magnitude, an event location attribute, an event jurisdiction, an event cost attribute, an event program population (e.g., how many people within the program are likely to be affected or otherwise influenced by the event), etc. Such event attributes and their corresponding values can be stored within the fields of a corresponding event object.

As illustrated in FIG. 2, events can also include program impact attributes 212 used to quantify how events can influence or affect a program. For example, a natural disaster could cause destruction of a facility, which impacts a program by requiring repair or replacement costs. In another example, an information security breach can impact a program by the release of sensitive information that can have financial and legal repercussions. As such, program impact attributes 212 can be associated with particular events, certain event types, particular programs, program types, etc. In embodiments, program impact attributes 212 can be associated with one or more program features 201, whereby program impact factors can affect a program by affecting one or more program features. In embodiments, program impact attributes 212 can comprise, or be based on, one or more event attributes. Program impact attributes 212 can also include a weighting factor according to a program or program type being analyzed. In this embodiment, for example, a program impact attribute representing an effect of a natural event, such as a hurricane, on a construction program, can be based on event attributes such as the hurricane's size, category, wind speeds, rain, etc., and weighted according to how those attributes can affect a construction program by the effect those attributes have on the physical presence (as reflected by program features) of the construction program (e.g., the machinery on-site, stage of the construction program, materials on site, susceptibility to flooding, expected infrastructure damage/outages outside of the program area, etc.).

At step 140, the database 103 can return a set of one or more events that can be considered relevant to the program of interest. The set of events can be ranked or ordered as desired, such as according to a score derived as a function of how well the events' attributes satisfy the selection criteria. It is also possible for the database 103 to return zero events if no events satisfy the query based on the selection criteria. If no events are returned, a message can be returned to the user indicating as such. In embodiments, the message can also include a request for additional program features, such as features missing from a set of features necessary to return at least one event.

The set of events can be in the form of a ranked list, which can be ranked according to a satisfaction score. The satisfaction score can be derived as a function of one or more event attributes and satisfaction criteria. In an example, the satisfaction criteria can be a threshold of a certain number of event attributes being met. Depending on the nature of the attribute namespace, the satisfaction score could comprise a calculated distance from the values within the satisfaction criteria to the actual event attributes within the attribute space. In embodiments where the attribute space comprises a multi-dimensional numeric space, the score could comprise a Euclidean distance.

At step 150, the engine 101 can select one or more events from the returned set of events on which to conduct a resilience analysis. The event(s) selected from the returned set of events can be selected based on a ranking or scoring of each event within the returned set. In embodiments, the event(s) selected can also be selected based on event category or event type, such as a top one or more events from one or more event categories or event types. In embodiments, the returned set of events can be presented to the user, wherein the user can select the desired event for the resilience analysis.

At step 160, the resilience management engine 101 uses one or more of the program impact attributes 212 of the selected event along with one or more of the program features 201 to derive one or more resiliency metrics for the program, where the resiliency metric indicates how resilient the program is with respect to an event having the nature of the selected event.

The resiliency metric can be a multi-valued metric (e.g., vector, N-tuple, etc.), showing various aspects of a program's resilience level for the selected event, the magnitude of those aspects, and interrelationships between those aspects. For example, the resiliency metric can include values associated with an estimated damage to the program, a program's ability to function during and after the event, a level of program functionality during and/or after the event, a projected loss, identified areas or “weak points” of the program most susceptible to the event, etc.

The resiliency metric can include be generated based on, and include statistical values associated with the resilience of the program (and/or various aspects of the program). For example, the resiliency metric can be generated via a Monte Carlo analysis, which generates an average metric value along with a confidence score from many simulations. The resiliency metric can include statistical ranges or percentages representing an estimated probability of failure of a “weak point” of a program. The resiliency metric can also include an overall risk of program failure due to the event, an estimated reduced capacity of the program due to the event, an estimated cost of the event (e.g., damage, recovery, preventative measures, cost of program operation at a reduced capacity, etc.), a time for acceptable restoration of the program, a time for full recovery of the program, etc.

Resiliency metrics can be dynamic with respect to time, wherein one created, a resiliency metric can be updated to incorporate new information related program features, event attributes, program impact attributes, or other information. Snapshots of a resiliency metric over time can be accessed by a user, which can be used to illustrate changes in a program resiliency over time and thus be used to identify trends in resiliency assessments.

Resiliency metrics can include differing values at different points in time. These changing resiliency metric values can reflect resiliency metric values that change based on periodic changes in one or more of program features, event attributes and program impact attributes. For example, the resiliency metric can vary based on a work schedule associated with a program, wherein the resiliency metric values can fluctuate based on the amount of people present at a program site during normal working hours versus an overnight period.

Resiliency metrics can have multiple levels of granularity. For example, resiliency levels in a resiliency metric can correspond to a program level, project level, workflow level, task level, asset level (e.g., facility, modules, assemblies, persons, parts, etc.), lifecycle levels (e.g., program phase, project phase, etc.) or other levels.

In embodiments, the resiliency metric can comprise one or more individual assessments regarding a program's ability to resist an event, to respond to the event, and to recover from the event. These assessments can be represented by a resistance measure, a response measure and a recovery measure, respectively. One or more of these measures can be used in generating the resiliency metric, either collectively or separately.

One should note that such measures can be a positive indication (great ability) or negative indication (poor ability). The values of the measures can depend on the algorithms use to make the derivations. In an embodiment, the measures can be a collective set of program features with additional data indicative of a positive or negative indication, and the degree of the indication.

In embodiments, the positive or negative indications associated with one or more measures can be reflective of a balance between several measures. For example, a generated resiliency metric of a certain level can indicate an acceptable resiliency against a particular event. However, if one of the measures is particularly low, then one or both of the others must be high enough to compensate in order to generate the resiliency metric having that level. This can be used to identify where an overall resiliency level of a program is acceptable, but that the constituent parts of the program that contribute to the resiliency are unbalanced.

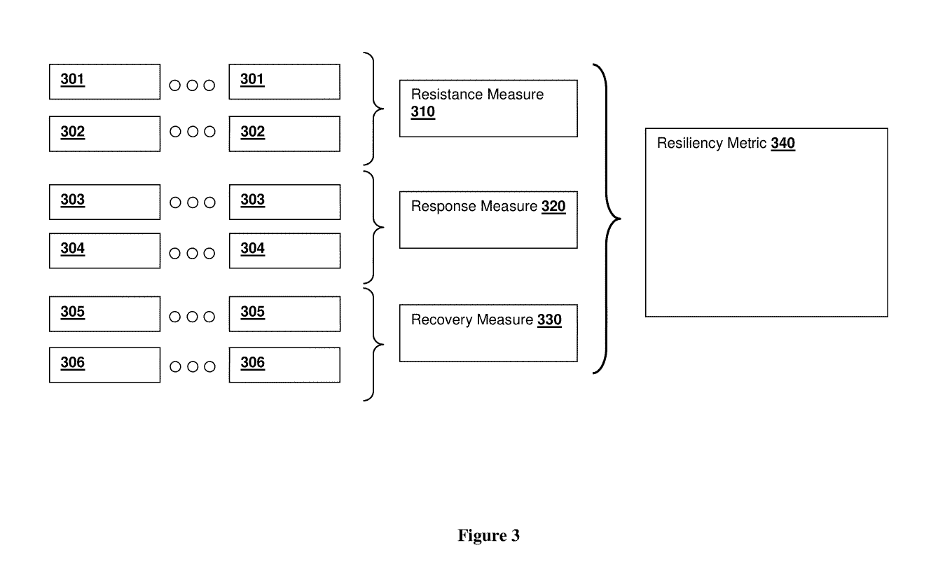

FIG. 3 provides an illustrative example of the generation of a resiliency metric 340 based on a resistance measure 310, a response measure 320 and a recovery measure 330.

The resistance measure 310 is representative of an ability of the program to resist the selected event. Thus, the resistance measure 310 can indicate a degree to which the program can maintain progress or functionality even in view of the event occurring. The resistance measure 310 can be indicative of a program's ability to resist the event as the event is occurring, as well as to resist the aftermath of an event. For example, a program's resistance measure regarding a hurricane can include the program's ability to resist the destruction of infrastructure or facilities due to the hurricane's high winds as well as the program's ability to resist the aftermath of the hurricane, such as an ability to function despite extended periods of power outages in the region due to the storm.

The resistance measure 310 of a resiliency metric can be generated based on resistance program features 301, which can be considered one or more program features 201 associated with event resistance and prevention, and program impact attributes 302 of an event that can affect or are otherwise associated with these program features. In other words, resistance program features 301 can be considered to be features associated with a readiness of a program, prior to the event occurring. Examples of program readiness can include a state of pre-event planning, pre-event program conditions, etc. For example, resistance program features 301 for a facility in preparation for a natural disaster event can include emergency notification capabilities, evacuation plans, sheltering capacity, physical condition of structures, personnel readiness (e.g., level of training of personnel, etc.), pre-positioning of emergency response teams, etc. These resistance features can include values reflecting a current state of each program feature, or can reflect a measure of resistance in terms of a resistance capacity, a percentage of resistance against a relative scale, etc. In turn, program impact attributes 302 used in deriving the resistance measure 310 can include those program impact attributes that program readiness is intended to resist. This can include event size, magnitude, as well as aspects of the event that represent specific threats to the program. In a hurricane event, for example, the program impact attributes 302 can include attributes associated with the categorization of the hurricane, the hurricane's size, a projected path, projected wind speeds, rain amounts, a time of passing at the facility site based on the size, and other predictive information typically associated with a hurricane event.

Resistance program features 301 can include features associated with a program's and/or organization's core capacity. Examples of features 301 corresponding to a core capacity can include features reflecting the extent of various program systems and program characteristics as relevant to resiliency needs, alternate path features, or system quality features.

The features related to various systems and program characteristics can include features associated with system resiliency characteristics. Examples of these features can include weak link features (e.g., identified weak points in the program system or subsystem(s)), current capacity features (e.g., current output, current speed, etc.), anticipated program downtime for a particular event (e.g., due to external or infrastructural damage outside of the program's system, how long to restart the program once external infrastructure is repaired, etc.), and program precaution features.

Alternate path features can be considered to represent the flexibility and adaptability of the organization and the systems, structures and components comprising the program. The flexibility and adaptability can be in general (e.g., in a normal operating environment) or in an event situation. Examples of alternate path features include replaceability features (e.g., how easily a particular aspect of a program can be replaced, in terms of cost, effort, equipment, availability of suitable replacements, etc.), reparability features (e.g., how easily a particular aspect of a program can be repaired to an acceptable working condition), interchangeability features (e.g., what aspects of a program can be used interchangeably, in case of a failure or decline in capacity of another program aspect), flexibility features (e.g., the ability for an aspect of a program to operate outside of normal operating parameters prior to failure), and adaptability features (e.g., the ability for an aspect of a program to “pick up the slack” for other aspects, the ability of an aspect of a program to be repurposed to assume additional program duties or functions, etc.). These features can be applied to various aspects of a program, such as system components, system structures, equipment, subsystems, processes, etc. These features can also be applied to various aspects of an organization, reflecting an organizations flexibility and adaptability.

System quality features can be considered features associated with a system's ability to survive design basis events intact, or if not completely intact, survive with a degraded but useful capability. System quality features can include capacity estimate features associated with particular design basis events of various magnitudes, a resistance feature (e.g., a maximum event or maximum magnitude of an event that the system is designed to survive intact), useful capability features (e.g., acceptable levels of capability or capacity for a particular event, or/and of a particular magnitude), functional time estimates (e.g., estimated time to failure for a system at various states of degradation), etc.

Resistance program features 301 can also include features that correspond to the nature of coupling systems or system components and the risk levels associated with any tight coupling. Examples of these features can include a coupling degree feature (e.g., how closely coupled are components in terms of a program, physical distance, communication network distance, etc.), a dependency feature (e.g., how dependent are components on coupled components for their functionality), a propagation feature (e.g., if a component fails, how easily will that failure propagate through the rest of the program via connected components, and how resistant are those coupled components to the failure, whether a coupled component can cause an amplification of the failure via a “snowball” effect, etc.), a coupling strength feature (e.g., how resistance the coupling itself is to failure during an event), etc. assessed by using information from a modeling assembly such as the 7D™ program execution system or the equivalent. In employing a 7D system has been employed for the program model, information used to derive program features can be intelligently extracted by the engine 101.

Resistance program features 301 can further include features associated with a program's degree of interoperability and degree of decentralized control. The degree of interoperability can include interoperability features reflecting the ability of various components and elements of a program to work reciprocally with one another. Interoperability features can include a connectivity feature, a compatibility feature, a synchronization feature, etc. Decentralized control can include control features reflecting a control scheme or organization for a program. Examples of control features can include a control hierarchy, a control map, a chain of command, a command location map (e.g., physical and/or networked location of each control authority), a control capacity (e.g., for an individual control authority, based on location, capabilities, etc.), or control communication features.

In assessing the inherent ability to resist off normal events as represented via the resistance measure, additional information related to the operating and maintenance phases of the specific facilities comprising a program can be considered. The operating phases can be represented by operation and failure rate features, whereas maintenance phases can be represented by maintenance features.

The operation and failure rate features can represent operating characteristics and failure rates of system structures and components. Operating features can include features associated with operational requirements (e.g., power requirements, space requirements, inputs, outputs, current operating efficiency, etc.). Failure rate features represent the failure rates for system structures and components. Failure rate features can also include associated failure rates for larger components, or for the program as a whole, that can be attributable to the failure of that component.

The data used in deriving operation and failure rate features can be obtained from assessed reviews of the operating characteristics and failure rates of systems, structures and components based on an experiential plant operating history as well as proprietary operating and maintenance databases that will consider appropriate analogs. This data can include measured performance data, estimated performance data, sensor data, output data, etc.

Maintenance features such as the nature of deferred maintenance (e.g., required maintenance versus recommended maintenance, preventative versus corrective maintenance, maintenance cost in terms of resources, time and/or monetary costs, maintenance procedures, etc.) and level of deferred maintenance (e.g., length of deferral, criticality of the maintenance, etc.). Via maintenance factors, deferred maintenance can be evaluated to assess both the nature and level of any such condition recognizing its contribution to degraded resiliency.

The response measure 320 is representative of a program's ability to respond to an event, including responses during the event and continuing into the immediate aftermath of the event. A program's ability to respond to an event can be assessed in areas such as the speed of a response, the effectiveness of a response, the reach of a response, the ability to predict immediate event effects (e.g., extent of damage, areas of damage, most critical areas post-event, etc.), the ability to predict secondary effects (e.g., in a natural disaster event, to predict flooding, power outages in the region, etc.), etc.

The response measure 320 can be generated based on response program features 303, which can be one or more program features 210 associated with a program's ability to respond to an event, and program impact attributes 304 of an event that can affect or are otherwise associated with the response program features 303. Examples of response program features can include features associated with response training programs and plans (e.g., adequacy of training programs and plans, extent of event-based training actually performed, assessment of training performance, currency/renewal of emergency training, adequacy of training for various phases of an event, etc.), assessed accessibility to critical infrastructure, availability of specialized assets (e.g., equipment, contracts, material, labor; can include assessed deficiencies in this availability), accessibility to repair materials (e.g., spare parts for emergency equipment, vehicles, and including on-side and off-site storage, equipment inventory pools and distribution, supply chain capacities, etc.), available system documentation (e.g., quality and currency of documentation, and clear interface points provided by the documentation, ability to contain or otherwise limit broader disturbances or damage, status of off-site emergency teams, etc.

A response to an event can be organized according to phases of an overall response stage. For example, the response to an event can include an event phase (i.e., during the event), a first response phase, a mobilization of initial relief phase, and a relief phase. As such, the response measure 320 can be generated according to assessments of one or more of these phases. The engine 101 can generate response measure 320 as a function of the various phase assessments. In one example, the response measure 320 can be an aggregation of the assessed phases, and the individual phases can be weighted, such as by criticality of the phase or dependence of a response on a particular phase. Each phase assessment can be generated according to response program features applicable to each phase.

As the phases in a response can be sequential in terms of chronology and/or execution, program features applicable to each phase can be linked or otherwise associated with program features of other phases, such as those program features sharing a causality relationship. For example, one or more features of the first response phase can be dependent on or influenced by features of the event phase. If a feature in the event phase reflects a poor state or preparation, it can have a corresponding effect on a dependent feature in the first response phase. This interrelationship among features can result in a particular phase assessment being affected by features of a phase before it. In certain situations, this effect can cascade along subsequent phases, and depending on the feature, can create a propagation or “snowball effect” of affected features in each subsequent phase. As such, the individual phase assessment can be affected and, consequently, so can the overall generation of the response measure 320.

In addition to one or more of the response program feature examples listed above, response program features associated with an event phase assessment can include predictive event effect features (e.g., nature of damage, type of damage, extent of damage, pattern of damage, etc.), predictive secondary effect features (e.g., areas at risk for secondary effects, nature of secondary effects, damage from secondary effects, etc.), currency of geospacial models (e.g., reflecting significant modifications of infrastructure or nearby areas due to the event, such as new or blocked flow channels or basins for a natural event), state of disaster assessment checklists for initial use (e.g., selection procedures for checklists, level of currency and refinement, etc.), alert capabilities for first response and initial relief resources (e.g., for prepositioned resources, and those that cannot be prepositioned), state of legal, regulatory, insurance or other enabling frameworks (e.g., identifying which are ready, which need updating, activating or modifying, etc.), activation of appropriate disaster response teams (e.g., teams associated with supplemental engineering assessment, or logistical support to first responders; can include from established disaster response organizations, commercial organizations, governmental organizations, and can include assessments of supplementary needs for each), disaster response team management and coordination plan readiness, etc.

In addition to one or more of the response program feature examples listed above, response program features associated with a first response phase assessment can include prioritization plans for response teams (e.g., focusing on life-saving activities, assisting with structural assessments such as for collapsed or partially collapsed structures, minimizing additional loss of life or injury, assessing additional potential hazards due to damage to structures, etc.), ability to update disaster assessment checklists in response to the actual situation assessed after the event, ability to identify evolving engineering and logistical needs during the first response and that will arise during the initial relief phases (e.g., ability to transition assessments to initial relief phase, assessments of shelter needs, availability and time to repair utility systems such as water, power, sanitary, etc.), capability to establish logistical centers to meet the needs of the first response phase and other response teams, etc.

In addition to one or more of the response program feature examples listed above, response program features associated with a mobilization phase assessment can include first responder support capabilities, equipment and team mobilization capacity (e.g., time to mobilize and efficiency in mobilization), ability to define emergency sheltering for ongoing response efforts (e.g., integrity and adequacy of existing sheltering options, identifying transitional shelter requirements, state of review plans for transitional shelter sites, etc.), identification of activities to be prioritized for execution in the initial relief phase, identification of long-lead transitional requirements, establishment of supply chains in response to identification of transitional requirements, capacity to provide engineering support for rescue operations, mobilization of remaining disaster assessment teams, etc.

In addition to one or more of the response program feature examples listed above, response program features associated with an initial relief phase assessment can include ability to conduct assessments of shelter conditions, ability to identify sources of basic needs (e.g., drinking water sources, medical supplies, food, electricity, clothing, etc.), emergency infrastructure restoration capabilities (e.g., level of expertise, manpower, equipment, removal of debris, structural assessments, continual evaluation of damaged structures and suitability of use, installation of temporary infrastructure, emergency dredging, modifying and adapting logistical change for landside cargo handling at airports, seaports, etc.), capacity to operate initial relief phase logistical centers, plans for deployment of initial relief teams according to various needs, staffing of teams, equipment status, capacity to assess physical infrastructures and assets for transitional purposes, and ability to identify logistical needs and activities in preparation for transition to a recovery step.

The recovery measure 330 can be generated based on recovery program features 305, which can be one or more program features 201 associated with a program's ability to recover from an event, and program impact attributes 306 of an event that can affect or are otherwise associated with these recovery program features 305.

Examples of recovery program features 305 can include features associated with a readiness of recovery scenarios for high probability events (e.g., rehearsal of scenarios, level of training, equipment readiness, future prevention, etc.), features associated with a readiness of recovery scenarios for catastrophic events (e.g., rehearsal of scenarios, level of training for catastrophic event recovery, equipment availability, equipment sources, etc.), features associated with a preparedness for post disaster reconstruction environment (e.g., project inputs, business framework, project setting framework, environment setting framework, stakeholder framework, economic and political framework, project and construction activity-specific challenges, changed project outputs, etc.), and features associated with a preparedness assessment (e.g., incorporating lessons learned from previous events affecting the program, lessons learned from similar events in other locations or affecting other programs, etc.).

A recovery stage can be made up of a series of phases. Recovery program features 305 relevant to each particular phase can then be used to assess each of the phases, which in turn can be used to assess the recovery stage in the form of the recovery measure 330. In embodiments, the recovery measure 330 can be generated based on a mobilization of transition phase, a transition phase, a mobilization of reconstruction phase, and a preparedness assessment phase.

The mobilization of transition phase involves a changeover from the initial relief phase of the response stage to the transition phase of the recovery stage. Much like the shift from first response to initial relief phases within the response stage, there will be an overlap and staggered shift from initial relief phase of the response stage to a transition phase of the recovery stage. As initial relief operations stabilize the post event situation, attention turns to providing the affected population with transitional assistance until reconstruction and other restoration activities can begin in earnest and ultimate transition to a new permanent condition completed. In the mobilization to transition phase, engineering, construction and logistical activities begin to take priority over other relief activities. Thus, in addition to one or more of the recovery program features 305 provided above, the features 305 associated with the mobilization of transition phase will be those features corresponding to essential engineering, construction and logistical activities that occur during this phase.

Examples of recovery program features 305 associated with the mobilization of transition phase include ability to assess elements of permanent potable water system (e.g., sources, equipment, infrastructure, etc.) to support the transition phase, ability to assess elements of permanent waste disposal systems (e.g., logistics, equipment, infrastructure, etc.) to support the transition phase, ability to assess infrastructure repair requirements to support transition and initial reconstruction phases (e.g., including mobilizing engineering and construction resources and assets necessary for the repairs), ability to assess of power generation repair and replacement requirements (including mobilizing necessary engineering and construction resources), ability to assess reconfigured power distribution networks to support transition and initial reconstruction phases, capacity to mobilize engineering, ability to assess logistical and construction resources to deploy and install transition phase infrastructure (e.g., logistical infrastructure, communications, shelter, staging areas, etc.), status of and capacity to mobilize labor-related training and employment activities (e.g., targeted local hire programs), and a capability to assess, negotiate and award long-lead contracts to support engineering, construction and logistical activities (e.g., package treatment plants, power generation and distribution equipment, bulk material supply contracts related to aggregate, concrete and steel, rubble and debris processing equipment, hazardous material cleanup and disposal in excess of that handled in initial relief, logistical operations, etc.).

The transition phase of a recovery stage covers a (possibly) extended period between the end of the initial relief phase and the start of permanent reconstruction, where final solutions are provided for the problems caused by the caused by event. Thus, the transition phase is focused on returning a semblance of normalcy in meeting population and local economy needs associated with a program while simultaneously completing planning, approvals, and resourcing for the permanent reconstruction phase. As such, the recovery program features 305 can include, in addition to one or more features 305 described above, features associated with engineering, construction and logistical activities that are ramped up to achieve a normalized state in preparation for reconstruction. Examples of recovery program features 305 associated with the transition phase can include engineering and construction capacity for permanent potable water systems to support transition phase, engineering and construction capacity for permanent waste disposal systems to support transition phase (e.g., liquid waste, solid waste, etc.), engineering and construction capacity of necessary infrastructure repairs to support transition and initial reconstruction phase activities, engineering and construction capacity related to permanent power generation system repairs and/or replacements, engineering and construction capacity of transition phase infrastructure (e.g., transition shelter site infrastructure), construction and logistical support capabilities for transition phase shelters, ability to execute labor-related training and employment activities (e.g., local-hire programs), capacity associated with the construction, installation and operation of contracted activities (e.g., package treatment plants, power generation and distribution equipment, bulk material supply contracts related to aggregate, concrete and steel, rubble and debris processing equipment, etc.), hazardous waste cleanup capabilities, capabilities associated with carrying out transition phase logistical operations, and ability to generate initial “lessons learned” assessments from engineering, construction and logistic standpoints.

The mobilization of reconstruction phase does not have to occur over a specific time frame following a particular sequence, as this phase is likely to vary based on the factors such as program itself, program and/or event location, extent of damage, and the build environment at the program site. As such, activities within the mobilization of reconstruction phase can take place concurrently with much of the transition phase. The recovery program features 305 associated with the mobilization of reconstruction phase can include, in addition to one or more of the features 305 listed above, features associated with a capacity to conduct reconstruction planning (e.g., public buildings such as government buildings, hospitals, schools, memorials, infrastructure, privately owned utilities and infrastructure, housing, industrial and commercial developments, etc.), an ability to conduct surveying to re-establish property lines and rights, abilities to conduct code modifications based on assessed “lessons learned” at early reconstruction stages, ability to secure permitting and approvals, ability to generate budget estimates and budget development, ability to secure funding and program management, engineering and construction activities (e.g., secured according to sector and funding sources, ensuring coordination to meet broad priorities and adequacy of logistical chain), ability to secure construction labor agreements, and an ability to define requisite safety, quality and inspection programs.

The reconstruction phase of the project can include post-mobilization activities as well as activities related to the reconstruction of the program itself. Activities of the reconstruction phase include an assessment of preparedness for the post-disaster reconstruction environment. This assessment can include several of the recovery program features 305 mentioned above, such as project input features, business frameworks features, project and environmental setting framework features, stakeholder framework features, project and construction activity special challenges features, and changed project output features.

The project input features reflect the basic reconstruction project inputs according to a simplified model: labor, materials, and equipment). In a disaster, these basic inputs are modified and new input considerations become significant. As such, the project input features can require an assessed state of labor, materials and equipment compared to anticipated changes in these features in result to an event. The changes can reflect additional requirements, considerations or modifications in the project input features. Labor project input features can reflect a state of labor relative to post-event changes such as new management skills, changed or expanded skilled labor requirements, unskilled labor pool mobilization capacity, labor sourcing, etc. Material project input features can reflect various states of material requirements and sequencing (changed as result of the event), disrupted supply chains (with respect to quantities), and new logistics challenges. Equipment project input features can represent equipment sourcing changes, equipment maintenance capacity, and status and availability of trained operators.

In a post-event situation, additional input factors arise. As such, these new input factors are represented as additional project input features of the reconstruction phase. Examples of these additional project input features can include knowledge of post-disaster construction features, subcontractor finance features, non-process infrastructure features (e.g., capacity for assessment, repair and/or replacement of traditional housing, provision and utility services, when and where these become disrupted or inadequate), ability to modify safety practices for post-disaster environment (e.g., ability to prepare for unknown conditions, ability to provide specialized craft training, adaptability regarding changes in work sequences, etc.), and stronger management systems role features (i.e., the ability to enhance a post-event construction phase management structure, such as for commercial transactions, labor documentation and payroll, and augmented work planning and management).

Business framework features account for changes caused by the event to aspects of construction such as contract considerations, which can significantly alter risk frameworks that a program or project team may encounter. This can result in the creation of new, de facto owner groups that differ from those that the engineering teams, construction teams, and the community at large had been working with previously. This change in ownership can in turn result in new challenges with various labor organizations. As such, the business framework features can include contract features (e.g., anticipating changes in scope such as including additional unknowns and anticipated evolving requirements, scheduling adaptation based on potential continuing risk events, degraded labor productivity, uncertain supply chains, and evolving approval frameworks, budgets based on uncertain and possibly fluid labor, equipment and/or materials costs due to increased competition for reduced post-event resources, and reassessment of quality standards based on existing and anticipated risks, intended usage and duration), risk framework features (e.g., anticipated changes in terms and conditions to reflect significant changes in a risk profile), ownership features (e.g., anticipated assumption of ownership by new groups, such as by external funding agencies), and labor organization and agreement features (e.g., barriers to recovery due to existing agreements, potential for labor strife due to mobilization of external work force, etc.).

Project and environmental setting framework can be considered as a single set of one or more features, and can reflect changes to the project and/or environment setting due to the event. For example, as a result of the event, one or more of site access, site geography and regional geography may have been drastically modified. Additionally, regional infrastructure relied upon by the program for basic needs may be substantially modified or non-existent. As such, pre-event assumptions are rendered invalid and cannot be relied up. As such, setting framework features reflecting anticipated changes can include project site features (e.g., site accessibility, denial of access, uncertain ownership or other property rights, etc.), geography features (e.g., modified topography such as flooding, landslides, mudslides, earthquake displacement, lava fields, aftermath of military action, etc., terrain limits of response or reconstruction, and constrained accessibility options), climate features (e.g., adverse climactic conditions such as continuing hurricane season, seasonal temperature or precipitation extremes, etc.), regional infrastructure features (e.g., destruction level of regional infrastructure affecting response and reconstruction, inadequacy of regional infrastructure for level and nature of response and reconstruction activities, etc.), social infrastructure features (e.g., state of disruption and/or destruction of housing, medical, police, fire, sanitation, financial institutions, etc.), records and documentation features (e.g., level of loss of records, lack of documentation regarding “as-builts” or other property rights, anticipated squatter disputes, etc.), and codes and standards features (e.g., anticipated evolution due to event, anticipated changes due to donor/funder requirements, etc.).

The stakeholder framework (which can include a social component) can undergo significant post-event changes, wherein traditional problem and dispute resolution mechanisms are rendered ineffective and wherein new problems can arise. In addition to the engineering and construction activities associated with rebuilding, stakeholder framework changes can include challenges associated with displaced populations, transient relief and reconstruction populations, and changes, emergence or re-establishment of cultural and/or tribal issues. Program features associated with the stakeholder framework can include organized stakeholder features (e.g., dysfunction among traditional stakeholder groups, evolving stakeholder objectives, emergence of new stakeholder groups, new roles and authority gained by national or international stakeholders allowing enablement and/or interference, etc.), demographics features (e.g., population loss and/or displacement, impact of relief, response and reconstruction populations, constraints on construction labor, etc.), cultural/religious features (e.g., transitional roles traditionally handled by cultural or religious groups, influence by these groups, elevated or “raw” cultural and/or religious sensitivities, resurfacing of tribal issues and prerogatives, etc.), and ownership rights features (e.g., level of existing documentation and records, likelihood of conflicting claims, assessment of formal versus informal rights, likelihood of confiscation in absence of rule of law, existence and level of corruption, etc.).

The economic and political framework reflects changes to the economic and political situations post-event. Program features associated with the economic and political framework post-event can include rule of law features (e.g., confiscation and security risks due to lack of rule of law, lack of consistency in interpretation and implementation of emergency decrees, local laws of convenience, corruption, etc.), regulation features (e.g., regulations irrelevant to post-event on-site situation and the degree to which they can impede progress, extension of existing regulations beyond their initial purpose or intent, etc.), financial institution features (e.g., absence or disruption in service or availability, emergence of cash economy, difficulties in paying suppliers and/or labor, etc.), program funding features (e.g., issues and requirements associated with multiple funding sources, evolving documentation abilities and requirements, lack of on-site ability for payment by donors, lack of timeliness in payments, etc.), political features (e.g., introduction of politics into traditionally non-political activities or forums, potential politicizing of activities, critical decisions affected by long range-planning efforts, considerations regarding economic development, importance of capacity building, etc.), and sustainability and resilience features (e.g., emergence of life-cycle focus).

Project and construction activity challenges can arise in a post-event environment due to changes brought about by the event. These challenges can be represented by program features representing debris removal capabilities, debris reuse capability, changes in psychology (e.g., decision-making psychology, risk-taking psychology, program psychology, labor force psychology due to displacement, loss, death, etc., and changes in liability standards and concerns. Some challenges can be associated with the exacerbated dangers and uncertainties of a post-event construction.

Post-event construction outputs can change based on the event and post-event environment. Typically, post-event construction focuses on permanent solutions and reconstruction. However, construction projects can take on temporary and transitional solutions in addition to permanent ones. Post-event pressures can exist that can affect the post-event construction processes and ultimate plans. For example, there can exist a pressure to use post-event debris in construction, which can affect planned designs and construction choices. Other pressures can exist associated with a consideration of not contributing debris and waste to the existing post-event environment during the construction process. Other pressures, such as social dimensions of the “triple bottom line” of sustainability can take increased importance in the construction process. Program features associated with post-construction outputs can include features associated with the post-event construction, as well as anticipated changes to the construction plans and processes due to an event. Examples of these program features can include completed program features (e.g., temporary, transitional and permanent construction features), construction waste features (e.g., debris and waste considerations related to disposal and reuse in construction, recycling drivers, etc.), and sustainability features (e.g., capacity building, economic development, new industry creation, enhanced resiliency, lessons learned and best practices, etc.).

The preparedness assessment phase is related to preparing for an inevitable “next event.” The preparedness assessment phase functions to assess the effectiveness of the pre-event preparations and to apply lessons learned from the event to future preparations so as to increase a program's resiliency to future events and avoid repeating past mistakes or shortcomings. The program features associated with a preparedness assessment phase can include those associated with lessons learned, such as those stored in a lessons learned database. The features can reflect the lessons learned themselves and/or the ability to implement, enact or otherwise incorporate lessons learned into pre-event planning and preparation. For example, lessons learned features can include observed costs associated with key decisions (e.g., did a decision regarding rubble disposal create delays or extra costs during a transition or reconstruction phase, did a decision regarding temporary infrastructure result in wasted efforts versus a permanent solution, were management frameworks implemented at earliest post-event periods create barriers to subsequent activities in subsequent periods, etc.), observed deficiencies of prior pre-event preparations (e.g., was the pre-event planning and preparation enough for the most recent events in light of preparedness assessments of prior events, did sufficient preparation in certain program areas after the previous event create deficiencies in other program areas, etc.), event-specific lessons features, program-specific lessons features, etc.

In addition to one or more of the resistance, response and recovery measures, additional program features 201 can be incorporated into the generation of the resiliency metric 340. These can be incorporated by way of measures of grouped features, or as individual features. One or more of these features can be weighted according to their relative influence or importance to a particular program, program type, program category, etc. These features can also be weighted according to their relative relevance to a particular event, event type, event size, event location, etc.

These additional features can include features associated with risk management plan assessment, organizational plan assessment, strategic decision making, resiliency management, context assessment, human factors, stakeholder awareness, and responsiveness of resiliency management plans to change.

Features associated with risk management plan assessment are those associated with the status and importance of, and attention given to, risk management plans within an organization. These can be used to confirm risk management plan assessment aspects such as current plan status, frequency of updates, extent of distributions or referrals of the plan to a determinable extent, etc. The adequacy of these plans can be measured against identified concepts related to resiliency. These concepts related to resiliency can be stored in a database, such as a proprietary resiliency database, for comparison and generation of associated features. Examples of these features can include plan status features (e.g., current status, update frequency and status, distribution status, etc.), resiliency address adequacy features (e.g., degree to which the plans adequately cover identified resiliency concepts), resiliency as strategic business objective features (e.g., strength of inclusion of resiliency as a strategic business objective of an organization), and expert judgment features (e.g., expert analysis and input according to internal and external experts and consultants, analysis gathered via expert systems implemented in resiliency assessments, etc.). In embodiments, the resiliency as strategic business objective features can itself be generated or derived based on a combination of expert judgment and input data, and semantic analysis data.

Program features associated with organization plan assessment can be considered those associated with assessing an extent to which risk management is an integral organizational process. These features can include feature reflecting an expert's semantic review and indexing of organizational process documentation such as procedures, forms and reports. Risks specifically assessed can be tabulated and compared to proprietary risk tables for completeness by the system 100. Examples of features associated with organization plan assessment can include risk management integral to organizational process features (e.g., the degree to which risk management aspects and functions are incorporated into organizational processes), risks specifically addressed features (e.g., degree of assessed risks as determined based on a comparison to reference risk tables such as the proprietary risk table), and plans for management of identified risk features (e.g., a degree to which plans exist that cover identified risks, a degree to which existing plans cover identified risks, a degree to which existing plans are actually implemented, etc.).

Program features associated with strategic decision making are those associated with assessed degrees to which risk management is integrated into decision making processes and the extent to which resiliency management is integrated into decision making processes. Examples of features associated with strategic decision making include resiliency as strategic business objective features (e.g., degrees to which resiliency is recognized as a strategic business objective), risk management part of decision making features (e.g., degree to which risk management is integrated into decision making processes, degree to which risk management influences decision making, observed actual implementation of risk management aspects into decisions, etc.), and resiliency management part of decision making features (e.g., degree to which resiliency management is integrated into decision making processes, degree to which resiliency management influences decision making, observed actual implementation of resiliency management aspects into decisions, etc.). The risk management part of decision making features and resiliency management part of decision making features can be derived from identified decision-making processes. Those processes and/or the identified risk and resiliency management aspects of the processes can be client-provided, or can be derived from the system based on an analysis of the processes, the programs the processes relate to, and impact of decisions on identified risk and/or resiliency features related to the program. In addition to contributing to the generation of the resiliency metric 340, program features associated with strategic decision making can also be used to generate secondary metrics, such as metrics directed to prioritizing choices and actions in decision-making and/or identifying alternative decision-making strategies. These secondary metrics can be generated as a function of existing decision-making processes, the level of integration of risk and resiliency management into decision making as reflected in their respective program features, and program features of the identified program. The generation of these secondary metrics can also incorporate baseline or reference decision-making processes generated for particular programs that incorporate acceptable or desired levels of resiliency and risk management, for the purposes of analysis or comparison.

Program features associated with resiliency management can include features associated with scenario-based resiliency analysis for a particular program. This can include features associated with identifying a spectrum of potential events (including specific considerations of uncertainty), organizational responses features (e.g., the range of responses considered, the extent of responses considered, at an organizational level), systemic response features (e.g., the range of systemic responses considered, the extent of systemic responses considered, etc.), nature and timing of recovery features (e.g., the degree to which the scenarios considered provided insight into timing and recovery, the quality of the insight provided, etc.), extent of organizational coverage features (e.g., scored organizational coverage associated with the adequacy of involvement of appropriate organizational elements), extent of lifecycle coverage (e.g., scored extent to which resiliency plans cover the entire lifecycle of a program, or that limitations have been adequately identified and communicated to appropriate organizational elements), and adequacy of information features (e.g., assessed adequacy of sources, limitations on gathered data, limitations on models and modeling systems, assessed adequacy and reliability of expert judgment such as from outside experts, internal experts, and expert systems, degree of cohesion and alignment of information, such as via statistical analysis, etc.).

Program features associated with context assessment can include features related to the adequacy of resiliency assessed against risk profiles in various contexts, such as inherent to a specific instance as well as to a broader industry. Examples of program features associated with context assessment can include internal risk profile features, external risk profile features, relative risk to peers features, overall industry risk profile features, and timely awareness of context features.

Program features associated with human factors can be features related to aspects of the human element, such as cognitive lock, “satisficing” or fear. Examples of these features can include employee relationship features (e.g., hierarchical relationship between employees, relationship between organization and employees, relationships between employees and individuals involved with resiliency efforts, etc.), willingness to deliver bad news features (e.g., assessed likelihood that bad news can be distributed and disseminated in an accurate and timely manner, assessed likely extent of bad news distribution upwards and downwards in a hierarchy chain, etc.), and willingness to consider new ideas features (e.g., adaptability based on seniority or customary practices, accepting new ideas from a lower or higher hierarchy level, etc.). These human factor program features can be derived from sources such as crowd-sourcing techniques, assessing known cultural and cross-cultural factors, observed relationships among employees, etc. It should be appreciated that each of the human factors are represented in the form of digital data as one or more quantitative scales or measures.

Program features associated with stakeholder awareness and involvement in resiliency includes features reflecting the assessed levels of awareness and involvement in program resiliency by various stakeholder groups. Examples of these features can include decision maker features (e.g., representing decision makers at all levels of an organization), employee features, key supplier features, pre-positioned response and recovery contractor features, key clients features, local government agency features, local utility and service provider features, regulator features (e.g., in situations where response or recovery actions can be subject to oversight or approval), and features associated with other major stakeholders. As such, these features can be incorporated such that a resiliency metric can be affected if a particular stakeholder is too aware or involved or not sufficiently aware or involved with resiliency planning and procedures in a program.

Program features related to responsiveness of resiliency management plans to change can be considered those program features that reflect the level to which an incorporation of changed conditions, processes, organizational or response capabilities into resiliency management programs can be performed in a timely and efficient manner. These program features can be generated based on an expert judgment reflecting the assessment of the resiliency management programs and their processes to incorporate changes.

In embodiments, the system 100 can also include one or more of a notification engine and a recommendation engine.

The notification engine can be configured to monitor trends in resiliency metrics to determine when changes occur in a program to a level that triggers a notification. Upon detection of triggering conditions, the notification engine or module can send the notification to designated recipients. For example, the notification engine can be triggered to create and distribute a notification if a resiliency metric value associated with a particular aspect of a program falls below a threshold resiliency metric value.

The recommendation engine can offer suggestions on how to make the program more robust against events to improve resiliency. The recommendation engine can monitor instant resiliency metric values as well as trending values using historical resiliency metric values to generate recommendations in response to instant program conditions as well as in response to developing program conditions over time. The recommendation engine can be configured to generate a recommendation based on a triggered notification, wherein recommendation can include one or more recommendations for correcting the notification-triggering situation.

The recommendation engine can generate a recommendation as a function of an analyzed resiliency metric condition (instant or trending) and a desired resiliency metric condition. In embodiments, the recommendation engine can assess the difference between the actual resiliency metric condition and the desired resiliency metric condition, and identify one or more program features responsible for the difference in the actual and desired resiliency metrics. The recommendation engine can then identify a degree of adjustment, for one or more of these identified program features, required to bring the actual resiliency metric of a program back in line with the desired resiliency metrics. The recommendation generated by the recommendation engine can then present suggested adjustments to various assets, stages, equipment, or other aspects of a program associated with the program features such that the changes to those program aspects result in a corrected resiliency metric for the program (or a change in trend towards a desired resiliency metric condition).

Recommendations based on differences between analyzed and desired metric conditions and/or suggested adjustments to one or more aspects of a program can be presented according to recommendation categories or themes. For example, a recommendation can be categorized as “recommended government and community cooperation”, where the recommendation can include recommended levels of interaction with government entities at the program location as well as the local community to set forth plans and procedures for assisting each other in post-event recovery. In another example, a recommendation can be related to pre-event engagement with engineering and construction communities. In this example, the recommendations can be directed to pre-placed contracts (e.g., recommended nature, amounts, advance planning, etc.) for program management, EPC, and supply chain concerns, early mobilization plans to a post-event zone, and planned early activation of logistics chains. In yet another example, the recommendations can be directed towards streamlined decision frameworks for post-event periods. These can include plans regarding decision authorities at a program and/or event site, and identified processes and situations that can affect logistical processes in a post-event situation (e.g., customs, building permits, liability legislation, etc.) as well as suggested modified logistical plans or templates for government consideration pre-event (e.g., “go-bys”, best practices, etc.).

At step 170, the engine 101 can present the resiliency metric(s), as well as any notifications and/or recommendations, via an output device (e.g., the program interface 102).

In embodiments, the program features used as inputs for the derivation of the resiliency metric can be the product of subassembly stage processing. At a subassembly stage, “lower-level” program features or other data can be used as inputs to generate higher level program features and/or program measures (e.g., the resistance, response and recovery measures, etc.). In embodiments, subassembly stages can be linked together using a level approach, whereby the program features generated by one or more subassembly stages can be used as input to a higher-level subassembly processing stage, and so on.

Subassembly stages can be organized such that the processing occurring at a particular subassembly is performed on program features or other input data having grouping similarities, data type similarities, temporal similarities, data update frequency similarities, etc. For example, a subassembly stage can generate program features according to the periodicity or frequency that its input data is available. As such, the program feature output can be considered to be the most current and can be relied upon by subsequent subassembly stages and, ultimately, in the generation of the resiliency metric. In another example, a subassembly stage can be used to process inputs associated with a particular aspect of resiliency, whereby the input data conforms to a set of known data input fields, field values, and standards. In this example, the subassembly stage can be used to properly correlate, weight, and otherwise analyze raw data inputs, transform, translate or otherwise normalize their input values, and generate one or more program features having outputs that can be properly incorporated by subsequent analysis.

In embodiments, some or all of the subassembly stages can be performed by the resilience management engine 101. In embodiments, some or all of the subassembly stages can be performed by subassembly engines. In embodiments, a subassembly engine can correspond to one single subassembly processing stage, and handle processing for only that stage. In embodiments, a subassembly engine can be responsible for more than one subassembly processing stage. In embodiments, some of the subassembly stage processing can be performed by the resilience management engine 101 and some of the subassembly stage processing can be performed by one or more subassembly engines. In other embodiments, all of the subassembly stage processing is performed by one or more subassembly engines, and the resilience management engine 101 receives program features from the highest-level subassembly engines, and uses these “finalized” program features and other input information, such as the program impact attributes of a selected event, to generate the resiliency metric as described elsewhere in this disclosure.

One or more of the subassembly engines can be integral to the resilience management engine 101, or separate from and in communication with the resilience management engine 101. As such, one or more of the subassembly engines can be embodied as computer-executable instructions stored on a non-transitory computer-readable medium, that cause a processor to execute their corresponding functions. In embodiments, one or more of the subassembly engines can be dedicated hardware computer processors, specially programmed to execute their corresponding functions.

By using a subassembly stage processing approach, the system 100 can “build up” the data from various sources such that the resiliency metric reflects the relative impact of the data from the various sources, thus accurately reflecting how those real-world factors affect the program's resiliency towards real-world events.

The processing techniques employed at each subassembly can depend on factors such as the nature of the input data, the nature of the desired output data, the category or “topic” of the subassembly, the importance of the subassembly (and/or one or more of the input and output data) relative to other subassemblies and/or relative to the program being analyzed, etc. In a given subassembly, more than one processing technique can be employed in combination. Examples of processing techniques can include aggregation algorithms (e.g., that aggregate input data to produce an aggregated output), mapping algorithms, statistical analysis algorithms (e.g., k-means clustering, nearest neighbor, means squared, probability algorithms, etc.), weighting functions, scoring algorithms, ranking algorithms, fuzzy logic algorithms, expert system algorithms, inductive reasoning algorithms, deductive reasoning algorithms, semantic analysis algorithms, inference engine algorithms, etc.

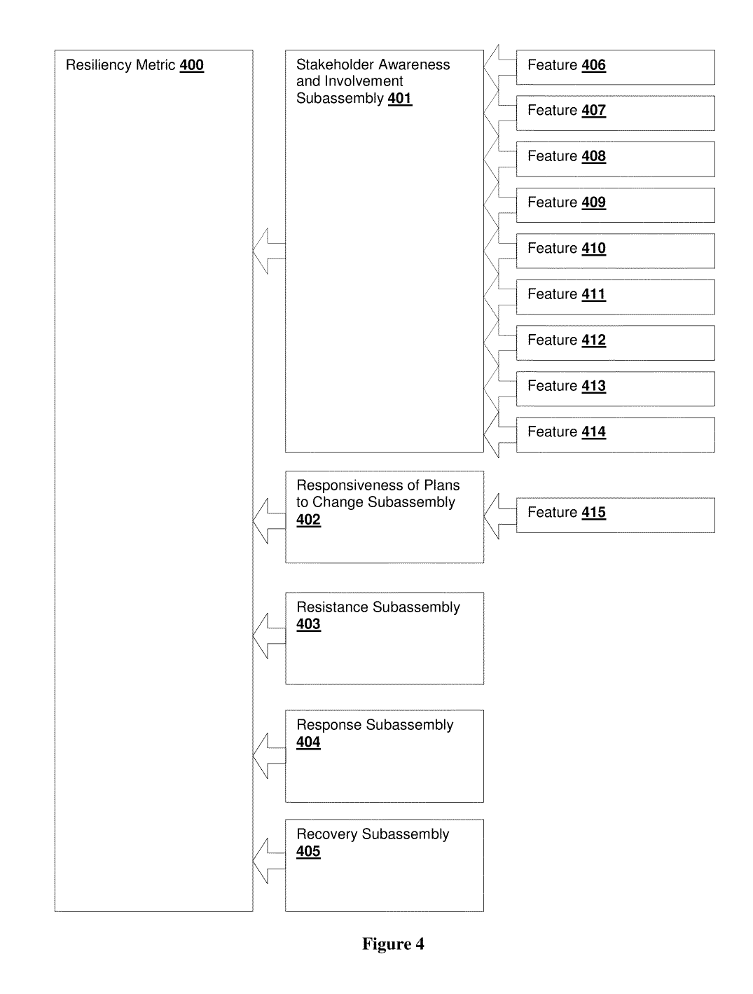

FIGS. 4-6 provides an example overview of the generation of a resiliency metric 400 via the subassembly approach. In this example, the resiliency metric 400 is generated using the subassemblies shown in FIG. 4-6, but the resiliency metric 400 can be generated using less than all of the shown subassemblies. In addition, the resiliency metric 400 can be generated using other subassemblies or individual program features in addition to the subassemblies and program features shown in the example.

FIG. 4 illustrates a stakeholder awareness and involvement subassembly 401 (hereinafter referred to as the “stakeholder subassembly 401”), a responsiveness of plans to change subassembly 402 (hereinafter referred to as the “responsiveness subassembly 402”, a resistance subassembly 403, a response subassembly 404, and a recovery subassembly 405.

As illustrated in FIG. 4, the stakeholder subassembly 401 can be used to produce an output based on one or more of the program features reflecting the assessed levels of awareness and involvement in program resiliency by various stakeholder groups. The program features used at stakeholder subassembly can include decision maker features 406 (e.g., representing decision makers at all levels of an organization), employee features 407, key supplier features 408, pre-positioned response and recovery contractor features 409, key clients features 410, local government agency features 411, local utility and service provider features 412, regulator features 413 (e.g., in situations where response or recovery actions can be subject to oversight or approval), and features associated with other major stakeholders 414. The output of the stakeholder subassembly 401 can be a stakeholder program feature. The stakeholder program feature can preferably be generated as via an aggregated or statistical grouping of one or more of the program features 406-414, using a weighting scheme for each of the features 406-414. The basis for the weighting scheme can be derived using surveying and interview techniques, whereby the weighting used for the features can be based on a derived relative positioning of each of the features based on analyzed survey and interview data.

The responsiveness of resiliency subassembly 402 generates an output program feature based on one or more input program features 415 that reflect the level to which an incorporation of changed conditions, processes, organizational or response capabilities into resiliency management programs can be performed in a timely and efficient manner. These input program features 415 can be generated based on an expert judgment reflecting the assessment of the resiliency management programs and their processes to incorporate changes.

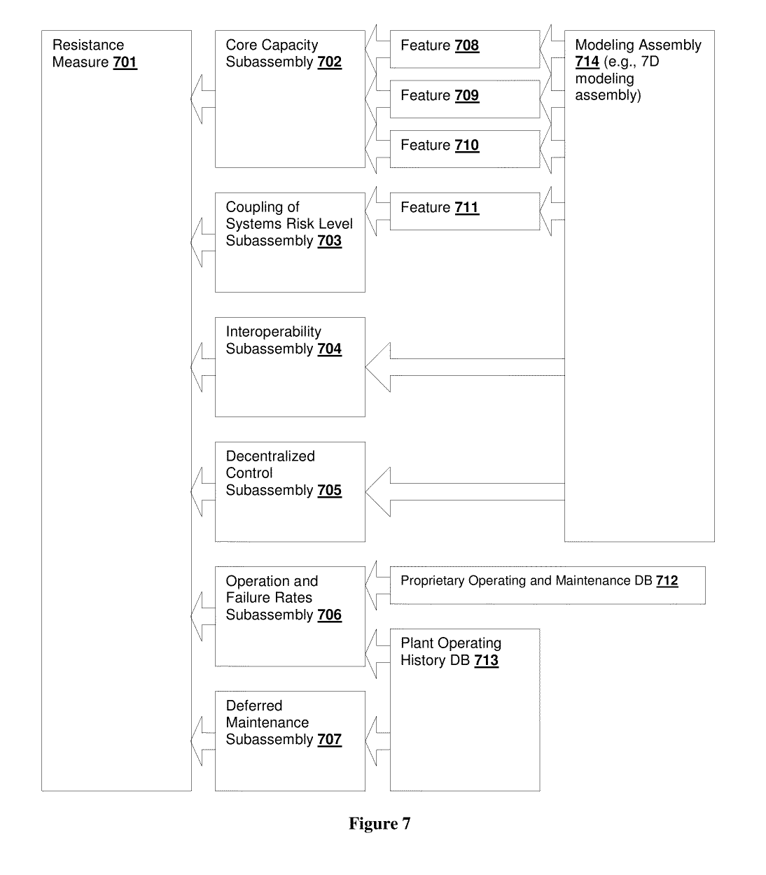

FIG. 4 illustrates that the output of the resistance, response and recovery subassemblies 403-405 can be used by the engine 101 in the generation of the resistance metric 400. The generation of the resistance, response and recovery measures at the resistance subassembly 403, the response subassembly 404, and the recovery subassembly 405, respectively, is illustrated in detail in FIGS. 7-9. In embodiments, an additional subassembly can be used to generate a combined “3R” measure that is based on one or more of the resistance, response and recovery measures generated by subassemblies 403-405, respectively.

As shown in FIG. 7, a resistance measure 701 can be generated based on the outputs generated at one or more subassemblies 702-707. The resistance measure 701 can be considered to be the resistance measure 310, generated using the subassembly approach.

The core capacity subassembly 702 generates one or more output program features based on input program features associated with a program's and/or organization's core capacity. These input features can include extent of systems and characteristics features 708 (e.g., program systems and characteristics as relevant to resiliency needs), alternate path features 709, and system quality features 710. In embodiments, the feature 708-710 can be received from a modeling assembly 714, such as the 7D modeling assembly, and the program features 708-710 can be the product of an executed modeling of the program's core capacity aspects. In embodiments, the features 708-710 can be generated by the system 100 based on information received from the modeling assembly 714, such as information associated with the execution of a program model by the modeling assembly 714.

Examples of feature 708 can include weak link features (e.g., identified weak points in the program system or subsystem(s)), current capacity features (e.g., current output, current speed, etc.), anticipated program downtime for a particular event (e.g., due to external or infrastructural damage outside of the program's system, how long to restart the program once external infrastructure is repaired, etc.), and program precaution features.

Examples of alternate path feature 709 include replaceability features (e.g., how easily a particular aspect of a program can be replaced, in terms of cost, effort, equipment, availability of suitable replacements, etc.), reparability features (e.g., how easily a particular aspect of a program can be repaired to an acceptable working condition), interchangeability features (e.g., what aspects of a program can be used interchangeably, in case of a failure or decline in capacity of another program aspect), flexibility features (e.g., the ability for an aspect of a program to operate outside of normal operating parameters prior to failure), and adaptability features (e.g., the ability for an aspect of a program to “pick up the slack” for other aspects, the ability of an aspect of a program to be repurposed to assume additional program duties or functions, etc.). These features can be applied to various aspects of a program, such as system components, system structures, equipment, subsystems, processes, etc. These features can also be applied to various aspects of an organization, reflecting an organizations flexibility and adaptability.

Examples of system quality features 710 can include capacity estimate features associated with particular design basis events of various magnitudes, a resistance feature (e.g., a maximum event or maximum magnitude of an event that the system is designed to survive intact), useful capability features (e.g., acceptable levels of capability or capacity for a particular event, or/and of a particular magnitude), functional time estimates (e.g., estimated time to failure for a system at various states of degradation), etc.

The coupling of systems risk level subassembly 703 generates one or more output program features based on input program features 711 that correspond to the nature of coupling systems or system components and the risk levels associated with any tight coupling. Examples of these features 711 can include a coupling degree feature (e.g., how closely coupled are components in terms of a program, physical distance, communication network distance, etc.), a dependency feature (e.g., how dependent are components on coupled components for their functionality), a propagation feature (e.g., if a component fails, how easily will that failure propagate through the rest of the program via connected components, and how resistant are those coupled components to the failure, whether a coupled component can cause an amplification of the failure via a “snowball” effect, etc.), a coupling strength feature (e.g., how resistance the coupling itself is to failure during an event), etc. In embodiments, the input program features 711 can received from the modeling system 714, or generated by the system 100 based on information gathered from the execution of a program model by the modeling system 714.

The interoperability subassembly 704 and decentralized control subassembly 705 can generate one or more output program features associated with a program's degree of interoperability and degree of decentralized control, respectively. The degree of interoperability can include interoperability features reflecting the ability of various components and elements of a program to work reciprocally with one another. Interoperability features can include a connectivity feature, a compatibility feature, a synchronization feature, etc. Decentralized control can include control features reflecting a control scheme or organization for a program. Examples of control features can include a control hierarchy, a control map, a chain of command, a command location map (e.g., physical and/or networked location of each control authority), a control capacity (e.g., for an individual control authority, based on location, capabilities, etc.), and control communication features. In embodiments, one or both of the interoperability subassembly 704 and decentralized control subassembly 705 can be a collection of one or more interoperability and/or control features created by the modeling subassembly 714 (or generated by the system 100 based on modeling output information generated by the modeling subassembly 714) that are provided without further modification or processing as inputs to the generation of the resistance measure 701.

The operation and failure rate subassembly 706 can generate one or more output program features based on input features representing operating characteristics and failure rates of system structures and components. Operating features can include features associated with operational requirements (e.g., power requirements, space requirements, inputs, outputs, current operating efficiency, etc.). Failure rate features represent the failure rates for system structures and components. Failure rate features can also include associated failure rates for larger components, or for the program as a whole, that can be attributable to the failure of that component. The input program features can be derived from data as described above, whereby the data can be retrieved from one or more of a proprietary operating and maintenance database 712 and from plant operating history databases 713 storing past observed plant operation conditions. The input program features can also be stored in one or both of the databases 712 and 713.

The deferred maintenance subassembly 707 can generate one or more output program features based on maintenance features such as the nature of deferred maintenance (e.g., required maintenance versus recommended maintenance, preventative versus corrective maintenance, maintenance cost in terms of resources, time and/or monetary costs, maintenance procedures, etc.) and level of deferred maintenance (e.g., length of deferral, criticality of the maintenance, etc.). Via maintenance factors, deferred maintenance can be evaluated to assess both the nature and level of any such condition recognizing its contribution to degraded resiliency. The maintenance features can be derived from data stored in plant operating history databases 713, and can also be stored in the same.

Additional program features associated with the resistance measure 701 can include features associated with emergency notification capabilities, evacuation plans, sheltering capacity, physical condition of structures, personnel readiness (e.g., level of training of personnel, etc.), pre-positioning of emergency response teams, etc. These additional program features can be used by one or more of the subassemblies 702-707, as applicable to the aspects of the program represented by the individual subassemblies. In embodiments, these additional program features can be used directly as inputs by the engine 101 in the generation of the resistance measure 701.

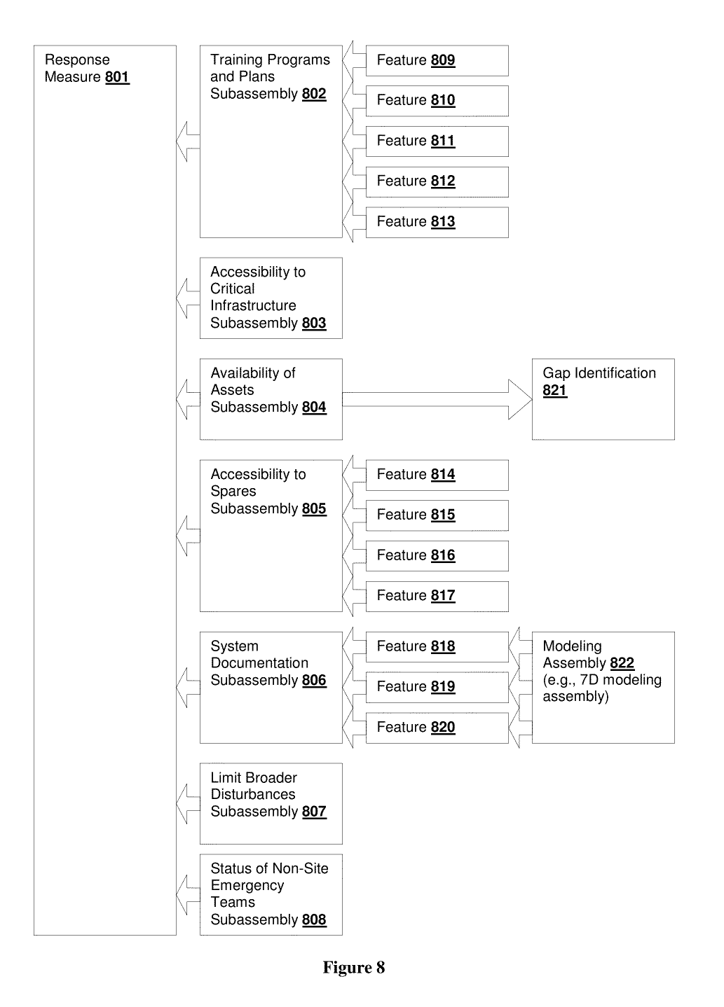

As shown in FIG. 8, a response measure 801 can be generated based on the outputs generated at one or more subassemblies 802-808. The response measure 801 can be considered to be the response measure 320, generated using the subassembly approach.

The generation of the response measure 801 can be based on the outputs of one or more of a training program and plans subassembly 802 (using input program features such as adequacy of training programs and plans 809, extent of event-based training actually performed 810, assessment of training performance 811, currency/renewal of emergency training 812, and adequacy of training for various phases of an event 813), an accessibility to critical infrastructure subassembly 803, an availability of specialized assets subassembly 804 (which can include input program features such as equipment, contracts, material, labor), accessibility to spares subassembly 805 (using input program features associated with the availability of repair materials, including on-side and off-site storage features 814 and 815, equipment inventory pools features 816 and distribution and supply chain capacities features 817. Other input program features can include spare parts for emergency equipment, vehicles, etc.), available system documentation subassembly 806 (using input program features including quality and currency of documentation features 818,818, and clear interface points provided by the documentation features 819), an ability to contain or otherwise limit broader disturbances or damage subassembly 807, and a status of off-site emergency teams subassembly 808.

The availability of assets subassembly 804 can also generate a gap identification program feature 821 representing identified gaps in the availability of assets. The gap identification program feature 821 can be used as the output program feature of the subassembly 804 used in the generation of the response measure 801, can be an output program feature in addition to other output program features generated by subassembly 804, or can be used as a program feature for other studies (e.g., input to models, report generation, etc.).

As illustrated in FIG. 8, the input program features 818, 819, 820 can be received from a modeling assembly 822 (such as the 7D modeling assembly), or generated by the system 100 based on information gathered from the execution of a program model by the modeling system 822.

As described above, a response to an event can be organized according to phases of an overall response stage. In the example described above, the response to an event can include an event phase (i.e., during the event), a first response phase, a mobilization of initial relief phase, and a relief phase. In embodiments incorporating subassemblies, one or more of these phases can be represented by corresponding subassemblies, with the program features corresponding to each phase (such as those discussed above) used as input program features for the phase subassemblies. The engine 101 can generate response the measure 801 as a function of the outputs of the phase subassemblies. The incorporation of the phase subassemblies can be in combination with or instead of one or more of the subassemblies illustrated in FIG. 8.

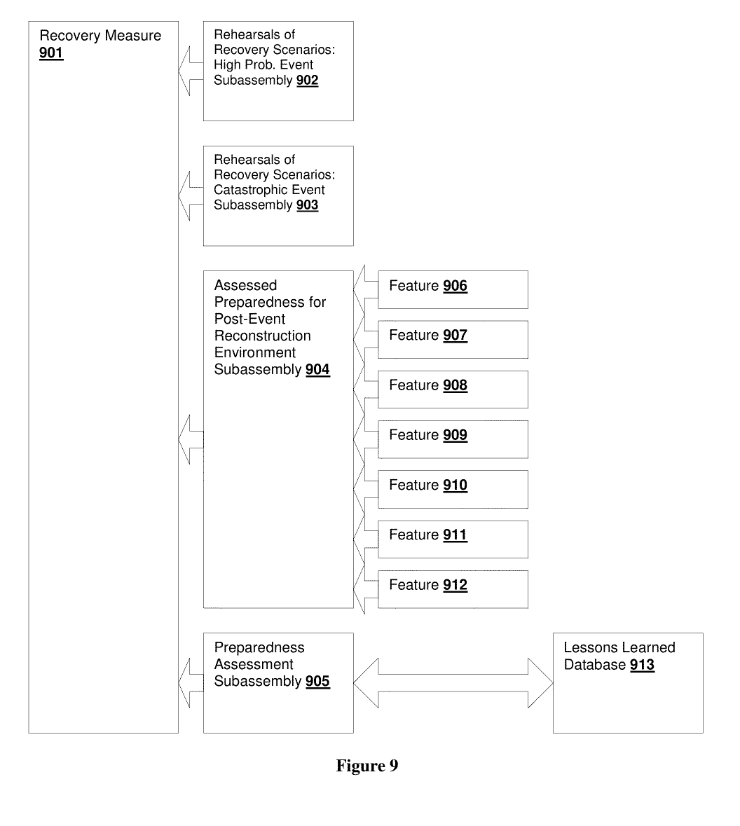

As shown in FIG. 9, a recovery measure 901 can be generated based on the outputs generated at one or more subassemblies 902-905. The recovery measure 901 can be considered to be the response measure 330, generated using the subassembly approach.

In the example illustrated in FIG. 9, the subassemblies used to generate the recovery measure 901 include a rehearsals of recovery scenarios: high probability event subassembly 902, a rehearsal of recovery scenarios: catastrophic event subassembly 903, an assessed preparedness for post-event reconstruction environment subassembly 904 (hereinafter “assessed preparedness subassembly 904”) and a preparedness assessment subassembly 905.

Input program features for the rehearsals of recovery scenarios subassemblies 902, 903 can include rehearsal of scenarios features, level of training features, equipment readiness features, and future prevention features associated with high probability events and catastrophic events, respectively.

The assessed preparedness subassembly 904 can generate output program features based on input program features such as project input features 906, business framework features 907, project and environment setting framework features 908, stakeholder framework features 909, economic and political framework features 910, project and construction activity-specific challenge features 911, and changed project outputs features 912.

The preparedness assessment subassembly 905 can generate output program features based on program features and/or additional information associated with lessons learned from previous events affecting the target program, lessons learned from similar events in other locations or affecting other programs, and the incorporation of these lessons learned. The subassembly 905 can retrieved data and/or generated program features from a lessons learned database 913, that can be used to aggregate lessons learned by an organization, an industry, etc., over time in response to events and regarding particular programs. The subassembly 905 can also provide generated output program features to the database 913 to enhance the database's collection of data for future use.

As described above, a recovery to an event can be organized according to phases of an overall recovery stage. In the example described above, the recovery to an event can include a mobilization of transition phase, a transition phase, a mobilization of reconstruction phase, and a preparedness assessment phase. In embodiments incorporating subassemblies, one or more of these phases can be represented by corresponding subassemblies, with the program features corresponding to each phase (such as those discussed above) used as input program features for the phase subassemblies. The engine 101 can generate response the measure 901 as a function of the outputs of the phase subassemblies. The incorporation of the phase subassemblies can be used to generate the measure 901 in combination with or instead of one or more of the subassemblies illustrated in FIG. 9.

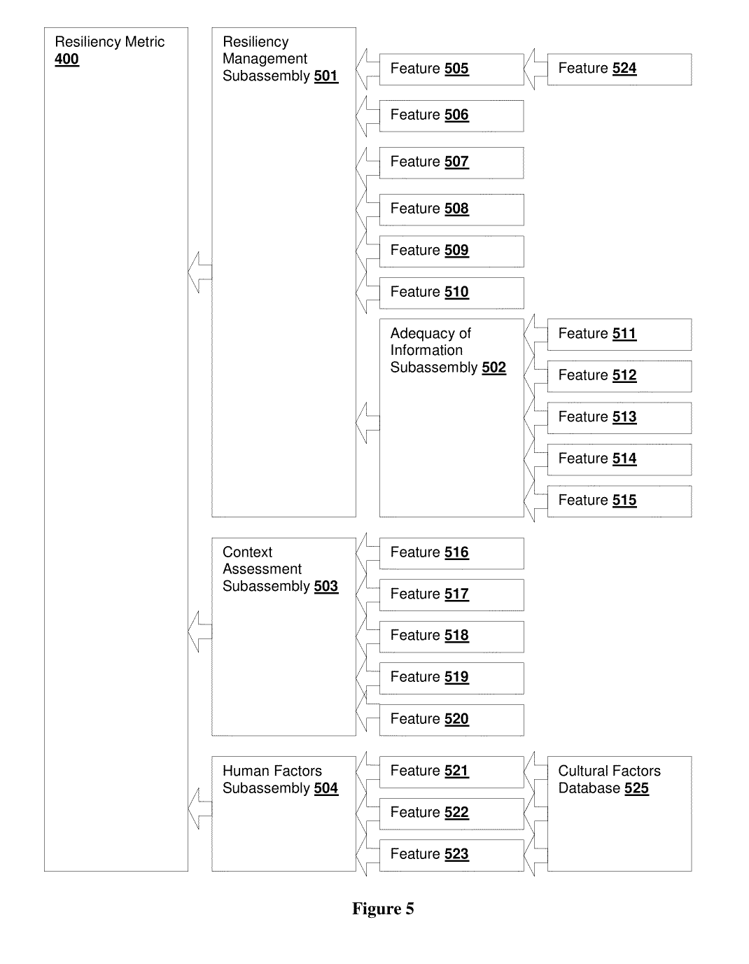

FIG. 5 illustrates a resiliency management subassembly 501, an adequacy of information subassembly 502, a context assessment subassembly 503, and a human factors subassembly 504.

As illustrated in FIG. 5, the resiliency management subassembly 501 encompasses an broad assessment of a range of resiliency management activities and processes via an combination of assessment techniques. As such, the resiliency management subassembly 501 can provide one or more output program features that can be used by the engine 101 in the generation of the resiliency metric 400. The input program features used by the resiliency management subassembly 501 include identification of a spectrum of events features 505, range of considered organizational response features 506, range of systemic responses considered features 507, nature and timing of recovery features 508, extent of organizational coverage features 509 and extent of lifecycle coverage features 510.

The identification of a spectrum of events features 505 can include data associated with uncertainty specifically considered features 524 (e.g., features reflecting that uncertainty was specifically considered, to a degree of confidence, reliability, quality, etc., among the identified spectrum of events). The data can be included in features 505 via a combination of features 505 and features 524 into new program features, or by changing one or more values of features 505 according to data contained in features 524.

FIG. 5 also provides an example of a hierarchical relationship between resiliency management subassembly 501 and adequacy of information subassembly 502. In the hierarchical structure, the adequacy of information subassembly 502 provides output program features to resiliency management subassembly 501. The resiliency management subassembly 501 can then use the program features generated by adequacy of information subassembly 502 in addition to program features 505-510. The adequacy of information subassembly 502 can create one or more output program features as a function of assessed adequacy of sources features 511, limitations on gathered data features 512, limitations on models and modeling systems features 513, assessed adequacy and reliability of expert judgment features 514 and degree of cohesion and alignment of information features 515.

The context assessment subassembly 503 can generate output program features based on input features related to the adequacy of resiliency assessed against risk profiles in various contexts, such as inherent to a specific instance as well as to a broader industry. The input program features used by context assessment subassembly 503 can include internal risk profile features 516, external risk profile features 517, relative risk to peers features 518, overall industry risk profile features 519, and timely awareness of context features 520.

The human factors subassembly 504 can generate output program features based on input program features including employee relationships features 521, willingness to deliver bad news features 522, and willingness to consider new ideas features 523. The program features 521, 522 and 523 can be retrieved from or generated based on information contained in a cultural factors database 525. The cultural factors database 525 can collect information from sources such as crowd-sourcing techniques, assessing known cultural and cross-cultural factors, observed relationships among employees, etc.

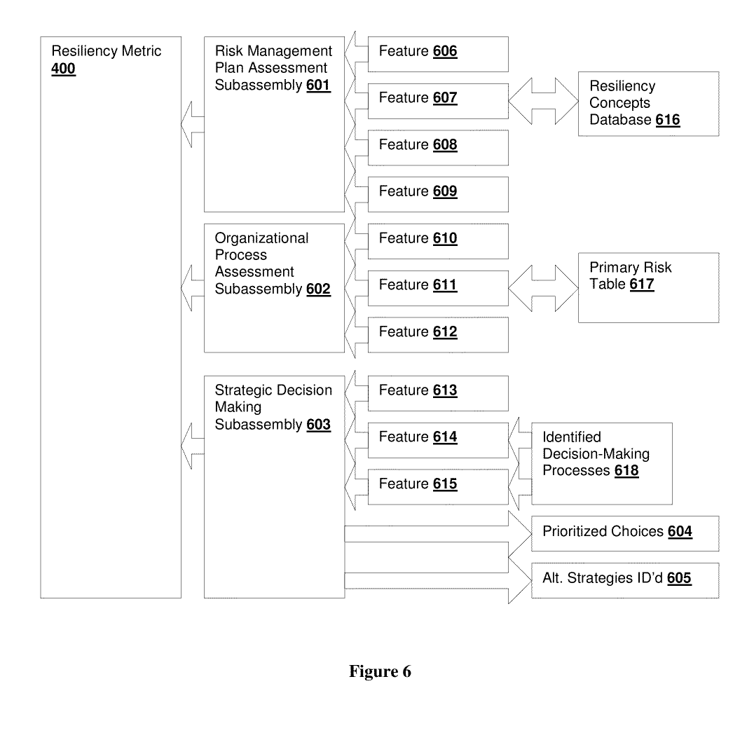

FIG. 6 illustrates a risk management plan assessment subassembly 601, an organizational process assessment subassembly 602, and a strategic decision-making subassembly 603. Also illustrated in FIG. 6 are the prioritized choices and actions output 604 and the alternative strategies identified output 605.

As illustrated in FIG. 6, the risk management plan assessment subassembly 601 can generate output program features based on input program features including plan status features 606, resiliency address adequacy features 607, resiliency as strategic business objective features 608, and expert judgment features 609.

The resiliency address adequacy features 607 can be retrieved from a resiliency concepts database 616. The resiliency concepts database 616 can be a proprietary database. Additionally, new program features generated by the subassembly 601 related to resiliency concepts can be added to the database 616.

The organizational process assessment subassembly 602 can generate output program features based on input program features including risk management integral to organizational process features 610, risks specifically addressed features 611, and plans for management of identified risk features 612. The risks specifically addressed features can be retrieved from or generated from data gathered from a primary risk table 617. Additionally, new program features or data generated by the subassembly 602 related to risks specifically addressed can be added to the primary risk table 617.

The strategic decision making subassembly 603 can generate output program features based on input program features including strategic decision making include resiliency as strategic business objective features 613, risk management part of decision making features 614, and resiliency management part of decision making features 615. The features 614 and 615 can be derived from information associated with identified decision making processes 618.

The strategic decision making subassembly 603 can also be used to generate prioritized choices and actions outputs 604 and alternative strategies outputs 605. The outputs 604 and 605 can include reports of tabulated prioritized choices and actions and reports of tabulated alternative strategies identified, respectively.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A program resiliency management system comprising:
a program interface configured to receive a program information including program features associated with a program;
an event database storing events, each event having event attributes and program impact attributes; and
a resilience management engine communicatively coupled with the program interface and the event database, and configured to:
obtain the program features via the program interface;
generate event selection criteria as a function of the program features;
identify a set of events having event attributes that satisfy the event selection criteria;
select a selected event from the set of events;
derive a resiliency metric of the program based on the program features and program impact attributes of the selected event; and
configure an output device to present the resiliency metric via the program interface.

2. The system of claim 1, wherein the program features include at least one of the following: a repair status, a training status, logistic features, personnel data, business objectives, plan status, subject matter expert review, stakeholder alignment data, cultural factors, supply chain data, regulations, and program history.

3. The system of claim 1, wherein the set of events includes at least one of the following types of events: a supply chain event, a natural event, a technology change, a personnel event, an internal project event, an internal program, an environmental event, a legislative event, and a regulatory event.

4. The system of claim 1, wherein the set of events includes a black swan event.

5. The system of claim 1, wherein the set of events includes at least two events.

6. The system of claim 5, wherein the set of events comprises a ranked list of event ordered according to a satisfaction score derived as a function of the event attributes and satisfaction criteria.

7. The system of claim 1, wherein the resiliency metric comprises a resistance measure representative of an ability of the program to resist the selected event as derived from program impact factors of the selected event and the program features.

8. The system of claim 1, wherein the resiliency metric comprises a responsiveness measure of representative of an ability of the program to respond to the selected event as derived from program impact factors of the selected event and the program features.

9. The system of claim 1, wherein the resiliency metric comprises a recovery measure of representative of an ability of the program to recover from the selected event as derived from program impact factors of the selected event and the program features.

10. The system of claim 1, wherein the resiliency metric comprises a multi-valued metric.

11. The system of claim 10, wherein the resiliency metric comprises statistical values.

12. The system of claim 10, wherein the resiliency metric comprises different values at different times.

13. The system of claim 12, wherein the resiliency metric is dynamic with respect to time.

14. The system of claim 1, wherein the resiliency metric comprises a multi-level metric.

15. The system of claim 14, wherein the resiliency metric reflects at least one of the following program levels: a program level, a project level, a workflow level, and a task level.

16. The system of claim 14, wherein the resiliency metric reflects at least one of the following lifecycle levels: a program phase and a project phase.

17. The system of claim 14, wherein the resiliency metric reflects at least one of the following asset levels: a facility, a module, an assembly, and a person.

18. The system of claim 1, further comprising a notification module configured to generate a notification based upon changes in the resiliency metric.

19. The system of claim 1, further comprising a recommendation engine configured to generate a recommendation on how to change the resiliency metric based on historical program data.
